(19) United States
(12) Patent Application Publication
(10) Pub. No.: US 2025/0150217 A1
(43) Pub. Date: May 8, 2025

(54) METHOD AND APPARATUS FOR MULTICAST HARQ-ACK FEEDBACK DETERMINATION

(71) Applicant: Lenovo (Beijing) Limited, Beijing (CN)

(72) Inventor: Haipeng Lei, Beijing (CN)

(73) Assignee: Lenovo (Beijing) Limited, Beijing (CN)

(21) Appl. No.: 18/727,964

(22) PCT Filed: Jan. 10, 2022
(86) PCT No.: PCT/CN2022/071068

§ 371 Date: Jul. 10, 2024

(51) Int. Cl. H04L 1/1829; H04L 1/1812; H04W 72/232; H04W 72/30

(52) U.S. Cl. CPC H04L 1/1864; H04L 1/1812; H04L 1/1854; H04W 72/232; H04W 72/30

(57) ABSTRACT

Embodiments of the present disclosure relate to HARQ-ACK feedback determination. According to some embodiments of the disclosure, a UE may: receive a first plurality of group-common DCI formats for scheduling a first plurality of PDSCHs for a multicast service, wherein each of the first plurality of group-common DCI formats includes a DAI; determine whether HARQ-ACK feedback for the first plurality of PDSCHs is disabled or enabled; generate a HARQ-ACK codebook for the multicast service based on the DAIs in the first plurality of group-common DCI formats; and transmit the HARQ-ACK codebook.

### TECHNICAL FIELD

Embodiments of the present disclosure generally relate to wireless communication technology, and more particularly to hybrid automatic repeat request acknowledgement (HARQ-ACK) feedback determination.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In a wireless communication system, a user equipment (UE) may monitor a physical downlink control channel (PDCCH) in one or more search spaces. The PDCCH may carry downlink control information (DCI), which may schedule uplink channels, such as a physical uplink shared channel (PUSCH), or downlink channels, such as a physical downlink shared channel (PDSCH). A UE may transmit hybrid automatic repeat request acknowledgement (HARQ-ACK) feedback corresponding to PDSCH transmissions through a physical uplink control channel (PUCCH) or a physical uplink shared channel (PUSCH).

The industry desires technologies for facilitating HARQ-ACK feedback transmission in a communication system.

### SUMMARY

Some embodiments of the present disclosure provide a user equipment (UE). The UE may include: a transceiver; and a processor coupled to the transceiver. The processor may be configured to: receive a first plurality of group-common downlink control information (DCI) formats for scheduling a first plurality of physical downlink shared channels (PDSCHs) for a multicast service, wherein each of the first plurality of group-common DCI formats may include a downlink assignment index (DAI); determine whether hybrid automatic repeat request acknowledgement (HARQ-ACK) feedback for the first plurality of PDSCHs is disabled or enabled; generate a HARQ-ACK codebook for the multicast service based on the DAIs in the first plurality of group-common DCI formats; and transmit the HARQ-ACK codebook.

Some embodiments of the present disclosure provide a base station (BS). The BS may include: a transceiver; and a processor coupled to the transceiver. The processor may be configured to: transmit a first plurality of group-common downlink control information (DCI) formats for scheduling a first plurality of physical downlink shared channels (PDSCHs) for a multicast service, wherein each of the first plurality of group-common DCI formats may include a downlink assignment index (DAI); and receive a hybrid automatic repeat request acknowledgement (HARQ-ACK) codebook for the multicast service, wherein the HARQ-ACK codebook may be generated based on the DAI in the first plurality of group-common DCI formats.

Some embodiments of the present disclosure provide a method for wireless communication performed by a user equipment (UE). The method may include: receiving a first plurality of group-common downlink control information (DCI) formats for scheduling a first plurality of physical downlink shared channels (PDSCHs) for a multicast service, wherein each of the first plurality of group-common DCI formats may include a downlink assignment index (DAI); determining whether hybrid automatic repeat request acknowledgement (HARQ-ACK) feedback for the first plurality of PDSCHs is disabled or enabled; generating a HARQ-ACK codebook for the multicast service based on the DAIs in the first plurality of group-common DCI formats; and transmitting the HARQ-ACK codebook.

Some embodiments of the present disclosure provide a method for wireless communication performed by a base station (BS). The method may include: transmitting a first plurality of group-common downlink control information (DCI) formats for scheduling a first plurality of physical downlink shared channels (PDSCHs) for a multicast service, wherein each of the first plurality of group-common DCI formats may include a downlink assignment index (DAI); and receiving a hybrid automatic repeat request acknowledgement (HARQ-ACK) codebook for the multicast service, wherein the HARQ-ACK codebook may be generated based on the DAI in the first plurality of group-common DCI formats.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates a schematic diagram of HARQ-ACK feedback determination in accordance with some embodiments of the present disclosure;

FIGS. 3A-3C illustrate a schematic diagram of HARQ-ACK feedback determination in accordance with some embodiments of the present disclosure;

FIGS. 4A and 4B illustrate a schematic diagram of HARQ-ACK feedback determination in accordance with some embodiments of the present disclosure;

FIG. 5 illustrates a flow chart of an exemplary procedure of wireless communications in accordance with some embodiments of the present disclosure;

FIG. 6 illustrates a flow chart of an exemplary procedure of wireless communications in accordance with some embodiments of the present disclosure; and

FIG. 7 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

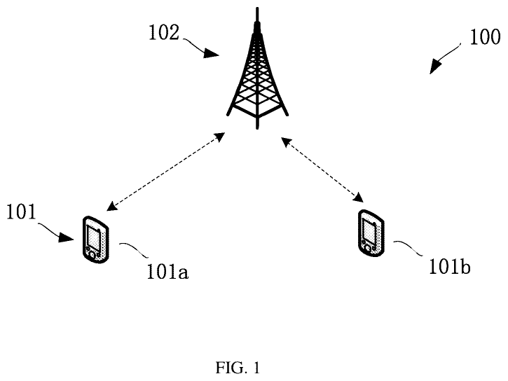

FIG. 1 illustrates a schematic diagram of a wireless communication system 100 in accordance with some embodiments of the present disclosure.

As shown in FIG. 1, wireless communication system 100 may include some UEs 101 (e.g., UE 101a and UE 101b) and a base station (e.g., BS 102). Although a specific number of UEs 101 and BS 102 are depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via uplink (UL) communication signals.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

In some embodiments of the present disclosure, the wireless communication system 100 may support multicast and broadcast services (MBSs). For example, one or more UEs (e.g., UE 101a and UE 101b) may be grouped as an MBS group to receive an MBS(s) (e.g., an MBS PDSCH) from a BS (e.g., BS 102).

A group-common radio network temporary identifier (RNTI) (e.g., group-RNTI (G-RNTI)) is introduced for an MBS so that a UE can differentiate a DCI format (hereinafter, “group-common DCI format”) scheduling a group-common PDSCH carrying an MBS service (e.g., an MBS PDSCH) from a DCI format scheduling a UE-specific PDSCH carrying a unicast service. For example, the cyclic redundancy check (CRC) of the DCI format scheduling the unicast PDSCH may be scrambled by a UE-specific RNTI (e.g., cell-RNTI (C-RNTI)) and the scheduled unicast PDSCH may also be scrambled by the UE-specific RNTI. The CRC of the DCI format scheduling the group-common PDSCH may be scrambled by a G-RNTI and the scheduled group-common PDSCH carrying the MBS may also be scrambled by the G-RNTI. When a UE supports multiple MBS services, each service may be configured with a G-RNTI specific to the service. In other words, from a UE's perspective, the G-RNTIs can be used to differentiate the multiple MBS services.

The HARQ-ACK feedback from the UEs corresponding to a downlink multicast transmission is essential for the multicast services in order to satisfy the QoS requirement, e.g., reliability. An MBS may support the enabling and disabling of the HARQ-ACK feedback.

In some embodiments of the present disclosure, radio resource control (RRC) signaling may be used to enable or disable the HARQ-ACK feedback for an MBS. This RRC configuration may be configured per a G-RNTI (e.g., per an MBS corresponding to the G-RNTI) by UE-specific RRC signaling. If HARQ-ACK feedback for a specific G-RNTI or MBS is enabled, a UE may transmit corresponding HARQ-ACK feedback in the indicated slot using the indicated PUCCH resource. Otherwise, if HARQ-ACK feedback for a specific G-RNTI or MBS is disabled, a UE may ignore the HARQ-ACK feedback related fields and not transmit corresponding HARQ-ACK feedback.

In some embodiments of the present disclosure, RRC signaling may be used to configure the presence of a field for indicating the enabling or disabling of the HARQ-ACK feedback (hereinafter, “HARQ-ACK feedback enabling/disabling indicator (HEI)”) in a group-common DCI format for multicast scheduling. The configuration may be configured per a G-RNTI (e.g., per an MBS corresponding to the G-RNTI). The HEI field may include one bit. Whether the HARQ-ACK feedback for a G-RNTI (or the corresponding MBS) is enabled or disabled may be determined based on the HEI field in the group-common DCI with the CRC scrambled by the G-RNTI.

In some embodiments of the present disclosure, the HARQ-ACK feedback enabling/disabling indicator (HEI) may only be included in a certain type of group-common DCI format (e.g., a non-fallback DCI format with at least one field size(s) configurable), and not included in another type(s) of group-common DCI format (e.g., a fallback DCI format with each field size fixed). For example, when RRC signaling configures the presence of the HEI in a DCI format with a CRC scrambled by a specific G-RNTI, the HEI is included in a non-fallback DCI format with a CRC scrambled by the specific G-RNTI, and is not included in a fallback DCI format with a CRC scrambled by the specific G-RNTI. This would cause an ambiguity for determining the HARQ-ACK feedback.

For clarity, the following text takes the non-fallback DCI format as an example of the DCI format that includes an HEI when configured, and takes the fallback DCI format as an example of the DCI format that always does not include an HEI. It is contemplated that the disclosed embodiments can also be applied to any other DCI formats.

For example, when a UE receives a fallback DCI format with a CRC scrambled by the specific G-RNTI, the UE cannot determine whether the HARQ-ACK feedback is enabled or disabled for the PDSCH scheduled by the fallback DCI format. For example, when such fallback DCI format is missed by a UE, the UE cannot determine whether the missed DCI format is a fallback DCI format or a non-fallback DCI format, and whether the missed DCI format enables or disables HARQ-ACK feedback. For example, when a non-fallback DCI format is missed by a UE, the UE cannot determine whether the missed DCI format is a fallback DCI format or a non-fallback DCI format or whether the missed DCI enables or disables HARQ-ACK feedback. Clearly, the UE cannot determine a HARQ-ACK codebook for the multicast service corresponding to the specific G-RNTI. Needless to say, when HARQ-ACK feedback for a unicast or HARQ-ACK feedback for another multicast service associated with another G-RNTI is to be multiplexed in the same HARQ-ACK codebook, it would be more problematic for the UE to determine the HARQ-ACK codebook. A misunderstanding of the HARQ-ACK codebook between a UE and a BS can easily occur.

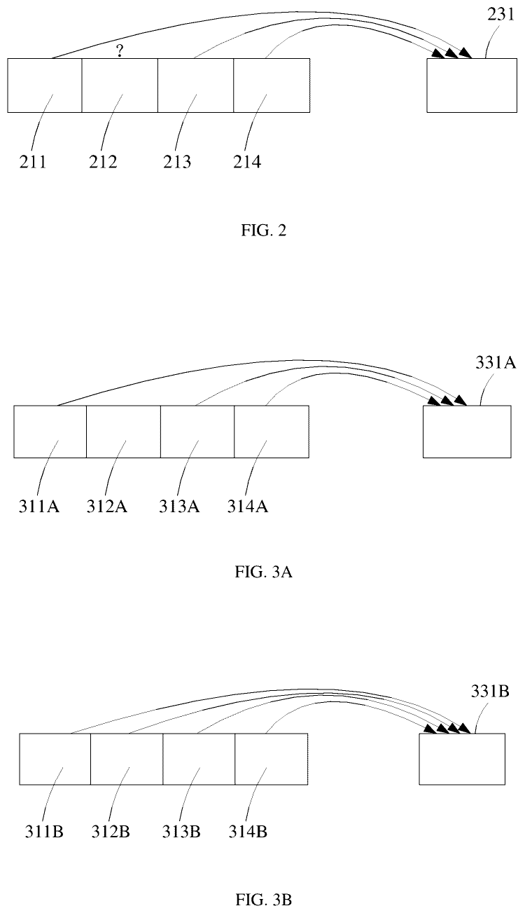

For example, referring to FIG. 2, it is assumed that a UE supports multicast service #A associated with G-RNTI #A. A BS may transmit, to the UE, four DCI formats 211-214 to schedule four PDSCHs (e.g., PDSCHs #1-#4) associated with multicast service #A. DCI formats 211, 213 and 214 may be non-fallback DCI formats and DCI format 212 may be a fallback DCI format.

In some embodiments, a downlink assignment index (DAI) in a DCI format may indicate the accumulative number of a {serving cell, PDCCH monitoring occasion}-pair(s) in which a PDSCH reception(s), a semi-persistent scheduling (SPS) PDSCH activation, or release, or a secondary cell (SCell) dormancy indication associated with the DCI formats is present, up to the current serving cell and current PDCCH monitoring occasion. For example, downlink assignment indexes (DAIs) of DCI formats 211-214 may equal 1, 2, 3, and 4 (e.g., “00”, “01”, “10”, and “11”), respectively.

In some examples, RRC signaling may configure the presence of the HEI in the non-fallback DCI format with a CRC scrambled by G-RNTI #A. In some examples, the BS may enable HARQ-ACK feedback for PDSCHs #1, #3, and #4 by enabling the HEIs in DCI formats 211, 213 and 214, for example, setting the HEIs to “1.” The BS may further indicate that HARQ-ACK feedback for PDSCHs #1, #3, and #4 is to be transmitted in the same slot (e.g., on PUCCH 231). In response to receiving DCI format 212, the UE cannot determine whether the HARQ-ACK feedback for PDSCH #2 is enabled or disabled since DCI format 212 does not include an HEI.

Moreover, assuming that DCI format 212 is missed by the UE, the UE can identify that a DCI format is missed between DCI format 211 and DCI format 213 according to the DAIs. However, the UE cannot determine whether the missed DCI is a fallback DCI format or non-fallback DCI format for multicast service #A and cannot determine whether the HARQ-ACK feedback for PDSCH #2 is enabled or disabled, either.

In addition, assuming that DCI format 211 is missed by the UE, the UE can identify that a DCI format is missed before DCI format 212 according to the DAI of DCI format 212. However, the UE cannot determine whether the missed DCI is a fallback DCI format or non-fallback DCI format for multicast service #A and cannot determine whether the HARQ-ACK feedback for PDSCH #1 is enabled or disabled, either.

As a result, the UE cannot determine a HARQ-ACK codebook for multicast service #A or cannot properly multiplex the HARQ-ACK feedback for multicast service #A with unicast HARQ-ACK feedback and HARQ-ACK feedback for another multicast service(s) in the same HARQ-ACK codebook.

Embodiments of the present disclosure provide solutions for HARQ-ACK codebook determination. For example, solutions for handling HARQ-ACK feedback associated with a fallback group-common DCI format are proposed. For example, solutions for handling HARQ-ACK feedback associated with a missed group-common DCI format are proposed. For example, solutions for determining a HARQ-ACK codebook for at least one multicast service are provided. For example, solutions for determining a HARQ-ACK codebook for at least one multicast service and a unicast service are provided. These solutions can solve the HARQ-ACK codebook misunderstanding between a UE and a BS. More details on the embodiments of the present disclosure will be illustrated in the following text in combination with the appended drawings.

In some embodiments of the present disclosure, when the HEI is configured to be present in a DCI format (e.g., a non-fallback DCI format) for a multicast service associated with a specific G-RNTI by, for example, RRC signaling, at least one field in a DCI format for the multicast service that does not include the HEI (e.g., a fallback DCI format) may be used to indicate whether the HARQ-ACK feedback of a PDSCH scheduled by the fallback DCI format for the multicast service is enabled or disabled.

In some embodiments, a bit in the fallback DCI format for the multicast service may be used to indicate enabled or disabled HARQ-ACK feedback for the PDSCH scheduled by the fallback DCI format. In some examples, the bit may be one of the reserved bit(s) in the fallback DCI format. In some examples, the bit may be a new bit in the fallback DCI format (e.g., by increasing the size of the fallback DCI format). This bit may always be presented in the fallback DCI format, and not configurable by RRC signaling, so as to guarantee that each field of the fallback DCI format is of a fixed size.

In some embodiments, a predefined value of a HARQ-ACK feedback relevant field(s) in the fallback DCI format for the multicast service may be used to indicate enabled or disabled HARQ-ACK feedback for the PDSCH scheduled by the fallback DCI format. For example, a HARQ timing indicator (HTI), a PUCCH resource indicator (PRI), or any combination thereof may be employed. For example, a predefined value of the HARQ-ACK feedback relevant field, such as setting PRI to “000” or setting HTI to “111”, may indicate disabled HARQ-ACK feedback for the scheduled PDSCH, and other values may indicate enabled HARQ-ACK feedback for the scheduled PDSCH. These other values can be interpreted according to their original intentions. For example, the PRI may indicate the PUCCH resource for carrying the HARQ-ACK feedback.

In some embodiments, an inapplicable value in the HARQ-ACK feedback timing set (also named “K1 set”, which may be provided by a high layer parameter dl-DataToUL-ACK as specified in 3GPP specification TS38.331) may be used to indicate disabled HARQ-ACK feedback for the scheduled PDSCH and other applicable values in the HARQ-ACK feedback timing set may be used to indicate enabled HARQ-ACK feedback for the scheduled PDSCH. For example, an HTI in a DCI format may indicate a value from the HARQ-ACK feedback timing set. When the indicated value is such inapplicable value (for example, a non-numerical value such as −1, or a value larger than the maximum allowed value such as 16 or 32 or 64), the UE may determine that the HARQ-ACK feedback for the PDSCH scheduled by the DCI format is disabled; otherwise, the UE may determine the HARQ-ACK feedback for the scheduled PDSCH is enabled.

In some embodiments, an invalid PUCCH resource may be used to indicate disabled HARQ-ACK feedback for the scheduled PDSCH and other valid PUCCH resources may be used to indicate enabled HARQ-ACK feedback for the scheduled PDSCH. For example, a PRI in a DCI format may indicate a PUCCH resource from a PUCCH resource set. When the indicated PUCCH resource is invalid, the UE may determine that the HARQ-ACK feedback for the PDSCH scheduled by the DCI format is disabled; otherwise, the UE may determine the HARQ-ACK feedback for the scheduled PDSCH is enabled. An invalid PUCCH resource can be a PUCCH resource with a zero-bit UCI payload. For example, an invalid PUCCH resource may include an invalid symbol duration (e.g., symbol duration>the number of symbols in a slot) or an invalid frequency resource bandwidth (e.g., PUCCH resource bandwidth>the maximum number of resource blocks of the serving cell).

In some embodiments, the DAI (e.g., counter DAI) in the fallback DCI format for the multicast service may be used to (implicitly) indicate enabled or disabled HARQ-ACK feedback for the PDSCH scheduled by the fallback DCI format. For example, when the value of the DAI in the fallback DCI format is equal to a predefined value (e.g., 0 or 4), the UE may assume that the HARQ-ACK feedback for the PDSCH scheduled by the fallback DCI format is disabled. Otherwise, the UE may assume that the HARQ-ACK feedback for the PDSCH scheduled by the fallback DCI format is enabled.

In some embodiments of the present disclosure, when the HEI is configured to be present in a DCI format (e.g., a non-fallback DCI format) for a multicast service associated with a specific G-RNTI, the DAI (e.g., counter DAI) in a DCI format (e.g., a fallback DCI format) for the multicast service that does not include the HEI may be used to (implicitly) indicate whether the HARQ-ACK feedback of a PDSCH scheduled by the fallback DCI format is enabled or disabled. The DAIs in non-fallback and fallback DCI formats for the multicast service may be used to arrange the HARQ-ACK information bits in a HARQ-ACK codebook or a HARQ-ACK sub-codebook for the multicast service.

In some embodiments, when the value of the DAI in a fallback DCI format (e.g., DCI #2A) for the multicast service is equal to the value of the DAI in a previous transmitted non-fallback DCI format (e.g., DCI #1A) for the multicast service, the UE may assume that the HARQ-ACK feedback for the PDSCH scheduled by the fallback DCI format is disabled. When another non-fallback DCI format (e.g., DCI #3A) is transmitted subsequent to the fallback DCI format (DCI #2A), the DAI of DCI #3A may be updated based on that in the previous transmitted non-fallback DCI format (e.g., DCI #1A), i.e., the value of the DAI in DCI #1A.

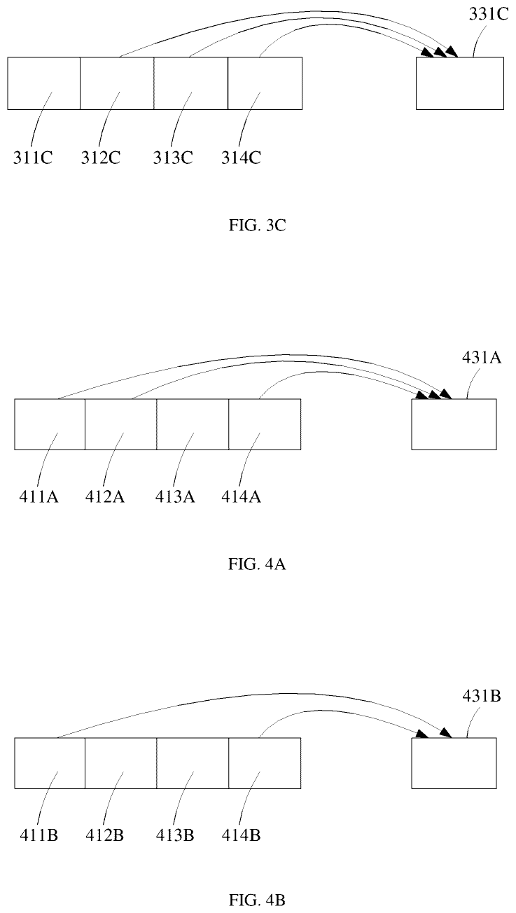

For example, referring to FIG. 3A, it is assumed that a UE supports multicast service #1 associated with G-RNTI #1. A BS may transmit, to the UE, four DCI formats 311A-314A to schedule four PDSCHs (e.g., PDSCHs #1A-#4A) associated with multicast service #1. In some examples, DCI formats 311A, 313A and 314A may be non-fallback DCI formats and DCI format 312A may be a fallback DCI format. The DAI of DCI format 311A may equal 1. If the DAI of DCI format 312A is the same as that of DCI format 311A (e.g., the DAI of DCI format 312A is equal to 1), the UE may determine that HARQ-ACK feedback for PDSCH #2A is disabled.

In some examples, the BS may enable HARQ-ACK feedback for PDSCHs #1A. #3A, and #4A by enabling the HEIs in DCI formats 311A, 313A and 314A. The BS may further indicate that HARQ-ACK feedback for PDSCHs #1A, #3A, and #4A is to be transmitted in the same slot (e.g., on PUCCH 331A). As shown in FIG. 3A, when the DAI of DCI format 312A is the same as that of DCI format 311A, the UE may determine that HARQ-ACK feedback for PDSCH #2A is disabled and transmit HARQ-ACK feedback for PDSCHs #1A. #3A, and #4A on PUCCH 331A.

On the other hand, when the value of the DAI in a fallback DCI format (e.g., DCI #2B) for the multicast service is updated (e.g., incremented by one) based on the value of the DAI in a previous transmitted non-fallback DCI format (e.g., DCI #1B) for the multicast service, the UE may assume that the HARQ-ACK feedback for the PDSCH scheduled by the fallback DCI format is enabled. When another non-fallback DCI format (e.g., DCI #3B) is transmitted subsequent to the fallback DCI format (DCI #2B), the DAI of DCI #3B may be updated based on that in the previous transmitted fallback DCI format (e.g., DCI #2B).

For example, referring to FIG. 3B, it is assumed that a UE supports multicast service #2 associated with G-RNTI #2. A BS may transmit, to the UE, four DCI formats 311B-314B to schedule four PDSCHs (e.g., PDSCHs #1B-#4B) associated with multicast service #2. In some examples, DCI formats 311B, 313B and 314B may be non-fallback DCI formats and DCI format 312B may be a fallback DCI format. The DAI of DCI format 311B may equal 1. If the DAI of DCI format 312B is updated based on that of DCI format 311B (e.g., the DAI of DCI format 312B is equal to 2), the UE may determine that HARQ-ACK feedback for PDSCH #2B is enabled.

In some examples, the BS may enable HARQ-ACK feedback for PDSCHs #1B, #3B, and #4B by enabling the HEIs in DCI formats 311B, 313B and 314B. The BS may further indicate that HARQ-ACK feedback for PDSCHs #1B-#4B is to be transmitted in the same slot (e.g., on PUCCH 331B). As shown in FIG. 3B, when the DAI of DCI format 312B is updated based on that of DCI format 311B, the UE may determine that HARQ-ACK feedback for PDSCH #2B is enabled and transmit HARQ-ACK feedback for PDSCHs #1B-#4B on PUCCH 331B.

In the above embodiments, the previous transmitted non-fallback DCI format (e.g., DCI #1A or DCI #1B) may be referred to as a reference non-fallback DCI format of the later transmitted fallback DCI format (e.g., DCI #2A or DCI #2B). In some embodiments, according to the DAI counting rule applied to non-fallback DCI formats, the reference non-fallback DCI format may need to satisfy a certain criterion.

For example, when the DAI of a non-fallback DCI format with disabled HARQ-ACK feedback (e.g., by a disabled HEI) follows that of a non-fallback DCI format with enabled HARQ-ACK feedback (e.g., by an enabled HEI) which is transmitted before the non-fallback DCI format with disabled HARQ-ACK feedback, the reference non-fallback DCI format can be either HARQ-ACK feedback enabled or disabled. “Follow” may mean that the DAI of the non-fallback DCI format with a disabled HEI is set to the same value as the DAI of the previously transmitted non-fallback with an enabled HEI.

For example, when the DAI of a non-fallback DCI format with disabled HEI does not follow that of a non-fallback DCI format with enabled HEI which is transmitted before the non-fallback DCI format with disabled HEI, the reference non-fallback DCI format should be a non-fallback DCI format with enabled HARQ-ACK feedback. “Not follow” may mean that the DAI of the non-fallback DCI format with a disabled HEI is updated (e.g., incremented by 1) based on the DAI of the previously transmitted non-fallback with an enabled HEI. Under this DAI counting rule, a non-fallback DCI format transmitted before a fallback DCI format indicates disabled HARQ-ACK feedback cannot be used as a the reference non-fallback DCI format.

In some embodiments, among the fallback DCI formats and the non-fallback DCI formats with corresponding HARQ-ACK feedback (if enabled) to be transmitted in the same slot (for example, the HTI in these DCI formats may indicate the same slot for transmitting HARQ-ACK feedback), a fallback DCI format of these DCI formats (hereinafter, “fallback DCI format #1”) may be transmitted earlier than all of the non-fallback DCI format(s) of these DCI formats. Several methods may be employed by the UE to determine whether the HARQ-ACK feedback for the PDSCH scheduled by the fallback DCI format is enabled or disabled.

In some embodiments, a UE may assume that the HARQ-ACK feedback for the PDSCH scheduled by fallback DCI format #1 is enabled. In some embodiments, the UE may assume that the HARQ-ACK feedback for the PDSCH scheduled by fallback DCI format #1 is disabled.

In some embodiments, when the DAI in a non-fallback DCI format (hereinafter, “non-fallback DCI format #1”), which is transmitted earlier than any other non-fallback DCI format(s) with corresponding HARQ-ACK feedback (if enabled) to be transmitted in the same slot, is updated based on the DAI in fallback DCI format #1, the UE may assume that the HARQ-ACK feedback for the PDSCH scheduled by fallback DCI format #1 is enabled. In some examples, the DAI of fallback DCI format #1 may be equal to a predefined value (e.g., 1).

A DAI (first DAI) being updated based on another DAI (second DAI) may mean that the second DAI is taken into account for determining HARQ-ACK codebook when determining the value of the first DAI is incremented (e.g., by 1) based on the value of the second DAI.

Otherwise, when the DAI in non-fallback DCI format #1 is not updated based on the DAI in fallback DCI format #1 (e.g., the DAIs in non-fallback DCI format #1 and fallback DCI format #1 are equal to the predefined value, or the DAIs in non-fallback DCI format #1 is restarted), the UE may assume that the HARQ-ACK feedback for the PDSCH scheduled by fallback DCI format #1 is disabled. A DAI being restarted may mean that the value of the DAI is set to a starting value (e.g., the predefined value) for DAI counting.

For example, still referring to FIG. 3B, in some examples, DCI formats 311B may be a fallback DCI format, and DCI formats 312B-314B may be non-fallback DCI formats. The DAI of DCI format 311B may equal a predefined value, for example, 1. If the DAI of DCI format 312B is updated based on that of DCI format 311B (e.g., the DAI of DCI format 312B is equal to 2), the UE may determine that HARQ-ACK feedback for PDSCH #1B is enabled. When DCI formats 312B-314B indicates a enabled HEI and HARQ-ACK feedback for PDSCHs #1B-#4B is to be transmitted in the same slot, the UE may transmit HARQ-ACK feedback for PDSCHs #1B-#4B on PUCCH 331B.

For example, referring to FIG. 3C, it is assumed that a UE supports multicast service #3 associated with G-RNTI #3. A BS may transmit, to the UE, four DCI formats 311C-314C to schedule four PDSCHs (e.g., PDSCHs #1C-#4C) associated with multicast service #3. In some examples, DCI formats 311C may be a fallback DCI format, and DCI formats 312C-314C may be non-fallback DCI formats.

The DAI of DCI format 311C may equal 1. If the DAI of DCI format 312C is the same as that of DCI format 311C (e.g., the DAI of DCI format 312C is also equal to 1), the UE may determine that HARQ-ACK feedback for PDSCH #1C is disabled.

In some examples, the BS may enable HARQ-ACK feedback for PDSCHs #2C-#4C by enabling the HEIs in DCI formats 312C-314C. The BS may further indicate that HARQ-ACK feedback for PDSCHs #2C-#4C is to be transmitted in the same slot (e.g., on PUCCH 331C). As shown in FIG. 3C, when the DAI of DCI format 312C is not updated based on that of DCI format 311C (e.g., the DAI of DCI format 312C is equal to 1), the UE may determine that HARQ-ACK feedback for PDSCH #1C is disabled and transmit HARQ-ACK feedback for PDSCHs #2C-#4C on PUCCH 331C.

In some embodiments of the present disclosure, when the HEI is configured to be present in a DCI format (e.g., a non-fallback DCI format) for a multicast service associated with a specific G-RNTI, since, for example, a fallback DCI format for the multicast service that does not include the HEI, fallback DCI formats for the multicast service with enabled HARQ-ACK feedback and non-fallback DCI formats for the multicast service with an enabled HEI may be grouped as a group (e.g., group #1) of DCI formats for counting the DAI values. Fallback DCI formats for the multicast service with disabled HARQ-ACK feedback and non-fallback DCI formats for the multicast service with a disabled HEI may be grouped as another group (e.g., group #2) of DCI formats for counting the DAI values. DAIs of the DCI formats in group #1 may be counted together while DAIs of the DCI formats in group #2 may be counted together. That is, DAIs may be counted separately among group #1 and group #2. The UE may not transmit HARQ-ACK feedback for PDSCHs scheduled by DCI formats in group #2.

For example, referring to FIG. 4A, it is assumed that a UE supports multicast service #4 associated with G-RNTI #4. A BS may transmit, to the UE, four DCI formats 411A-414A to schedule four PDSCHs (e.g., PDSCHs #1D-#4D) associated with multicast service #4. In some examples, DCI formats 411A, 413A and 414A may be non-fallback DCI formats and DCI format 412A may be a fallback DCI format.

Assuming that the HEIs in DCI formats 411A and 414A are enabled, the HEI in DCI formats 413A is disabled, and HARQ-ACK feedback for PDSCH #2D is enabled, group #1 may include DCI formats 411A, 412A and 414A and group #2 may include DCI format 413A. DAIs of the DCI formats may be counted among the two groups. For example, the DAI in DCI format 412A may be updated based on that in DCI format 411A. For example, DAIs in DCI formats 411A-414A may equal 1, 2, 1, and 3, respectively. Since DCI format 411A indicates an enabled HEI, the UE may determine that HARQ-ACK feedback for PDSCH #2D is enabled. The UE may transmit HARQ-ACK feedback for PDSCHs #1D, #2D and #4D on PUCCH 431A.

For example, referring to FIG. 4B, it is assumed that a UE supports multicast service #5 associated with G-RNTI #5. A BS may transmit, to the UE, four DCI formats 411B-414B to schedule four PDSCHs (e.g., PDSCHs #1E-#4E) associated with multicast service #5. In some examples, DCI formats 411B, 413B and 414B may be non-fallback DCI formats and DCI format 412B may be a fallback DCI format.

Assuming that the HEIs in DCI formats 411B and 414B are enabled, the HEI in DCI formats 413B is disabled, and HARQ-ACK feedback for PDSCH #2D is disabled, group #1 may include DCI formats 411B and 414B and group #2 may include DCI formats 412B and 413B. DAIs of the DCI formats may be counted among the two groups. For example, DAIs in DCI formats 411B-414B may equal 1, 1, 2, and 2, respectively. Since the DAI in DCI format 412B is not updated based on that in DCI format 411B which indicates an enabled HEI and the DAI in DCI format 413B which indicates a disabled HEI is updated based on that in DCI format 412B, the UE may assume that HARQ-ACK feedback for PDSCH #2E is disabled. The UE may transmit HARQ-ACK feedback for PDSCHs #1E and #4E on PUCCH 431B.

In some embodiments of the present disclosure, when the HEI is configured to be present in a DCI format (e.g., a non-fallback DCI format) for a multicast service associated with a specific G-RNTI, RRC signaling may configure whether the HARQ-ACK feedback for a PDSCH scheduled by a DCI format (e.g., a fallback DCI format) for the multicast service that does not include the HEI is enabled or disabled.

In some embodiments of the present disclosure, when the HEI is configured to be present in a DCI format (e.g., a non-fallback DCI format) for a multicast service associated with a specific G-RNTI, the HARQ-ACK feedback for a PDSCH scheduled by a DCI format (e.g., a fallback DCI format) for the multicast service that does not include the HEI may be always enabled or disabled, for example, predefined as enabled or disabled.

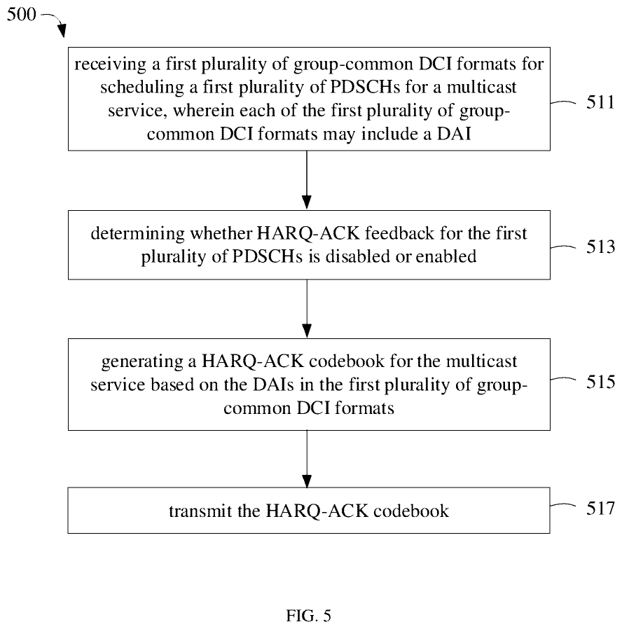

FIG. 5 illustrates a flow chart of an exemplary procedure 500 for wireless communications in accordance with some embodiments of the present disclosure. Details described in all of the foregoing embodiments of the present disclosure are applicable for the embodiments shown in FIG. 5. In some examples, the procedure may be performed by a UE, for example, UE 101 in FIG. 1.

Referring to FIG. 5, in operation 511, a UE may receive a first plurality of group-common DCI formats for scheduling a first plurality of PDSCHs for a multicast service, wherein each of the first plurality of group-common DCI formats may include a DAI.

In operation 513, the UE may determine whether HARQ-ACK feedback for the first plurality of PDSCHs is disabled or enabled. In operation 515, the UE may generate a HARQ-ACK codebook for the multicast service based on the DAIs in the first plurality of group-common DCI formats. In operation 517, the UE may transmit the HARQ-ACK codebook.

In some embodiments of the present disclosure, determining whether HARQ-ACK feedback for the first plurality of PDSCHs is disabled or enabled may include determining whether HARQ-ACK feedback for a first PDSCH of the first plurality of PDSCHs scheduled by a first group-common DCI format of the first plurality of group-common DCI formats is disabled or enabled based on at least one of the following: a bit in the first group-common DCI format; whether a HARQ-ACK feedback related indicator in the first group-common DCI format is equal to a predefined value or not; whether an HTI in the first group-common DCI format indicates an inapplicable value or not; whether a PRI in the first group-common DCI format indicates an invalid PUCCH resource or not; or whether the DAI in the first group-common DCI format is equal to a predefined value or not. In some examples, the HARQ-ACK feedback related indicator may include the HTI, the PRI, or any combination thereof

In some embodiments of the present disclosure, the UE may receive a second plurality of group-common DCI formats for scheduling a second plurality of PDSCHs for the multicast service, wherein each of the second plurality of group-common DCI formats includes a DAI and an HEI. Generating the HARQ-ACK codebook for the multicast service may include generating the HARQ-ACK codebook based on the DAIs in the first plurality of group-common DCI formats and the DAIs and HEIs in the second plurality of group-common DCI formats.

In some embodiments of the present disclosure, a DAI in a first group-common DCI format of the first plurality of group-common DCI formats may indicate whether the HARQ-ACK feedback for a first PDSCH scheduled by the first group-common DCI format is enabled or disabled.

In some examples, determining whether the HARQ-ACK feedback for the first plurality of PDSCHs is disabled or enabled may include at least one of: determining that the HARQ-ACK feedback for the first PDSCH is disabled in response to the DAI in the first group-common DCI format being the same as that in a second group-common DCI format of the second plurality of group-common DCI formats, which is transmitted earlier than the first group-common DCI format; or determining that the HARQ-ACK feedback for the first PDSCH is enabled in response to the DAI in the first group-common DCI format being updated based on that in the second group-common DCI format. In some examples, the HEI in the second group-common DCI format may indicate enabled HARQ-ACK feedback. In some examples, the HEI in the second group-common DCI format may indicate disabled HARQ-ACK feedback.

In some examples, determining whether the HARQ-ACK feedback for the first plurality of PDSCHs is disabled or enabled may include, in response to the first group-common DCI format being transmitted earlier than all of the second plurality of group-common DCI formats: determining that the HARQ-ACK feedback for the first PDSCH is disabled; determining that the HARQ-ACK feedback for the first PDSCH is enabled; determining that the HARQ-ACK feedback for the first PDSCH is disabled when the DAI in the first group-common DCI format is equal to a predefined value and the DAI in a second group-common DCI format of the second plurality of group-common DCI formats which is transmitted earlier than any other group-common DCI formats of the second plurality of group-common DCI formats is equal to the predefined value or restarted; or determining that the HARQ-ACK feedback for the first PDSCH is enabled when the DAI in the second group-common DCI format is updated based on the DAI in the first group-common DCI format.

In some embodiments of the present disclosure, the DAIs may be counted separately among a first group of group-common DCI formats and a second group of group-common DCI formats. The first group of group-common DCI formats may include group-common DCI formats each with enabled HARQ-ACK feedback from the first plurality of group-common DCI formats and group-common DCI formats each with an enabled HEI from the second plurality of group-common DCI formats. The second group of group-common DCI formats may include group-common DCI formats each with disabled HARQ-ACK feedback from the first plurality of group-common DCI formats and group-common DCI formats each with a disabled HEI from the second plurality of group-common DCI formats.

In some embodiments of the present disclosure, the UE may receive RRC signaling indicating whether the HARQ-ACK feedback for the first plurality of PDSCHs is enabled or disabled. In some embodiments of the present disclosure, the HARQ-ACK feedback for the first plurality of PDSCHs may be predefined as enabled or disabled.

It should be appreciated by persons skilled in the art that the sequence of the operations in exemplary procedure 500 may be changed and some of the operations in exemplary procedure 500 may be eliminated or modified, without departing from the spirit and scope of the disclosure.

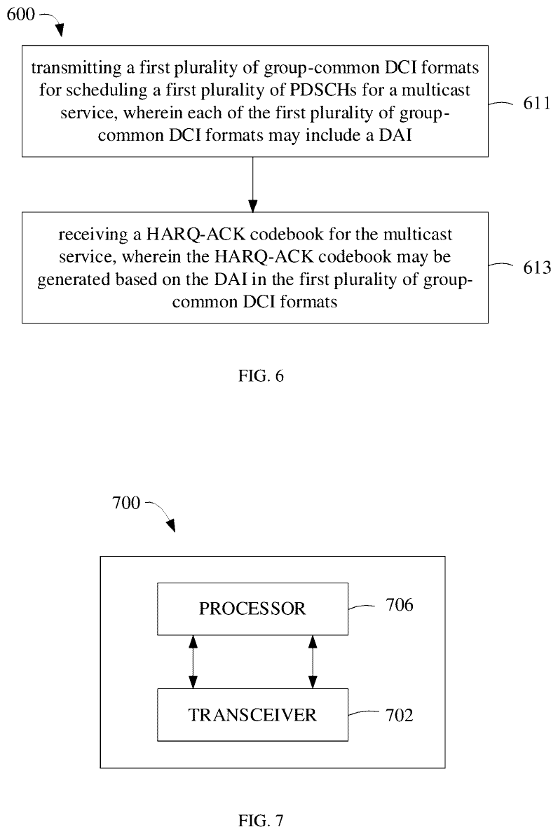

FIG. 6 illustrates a flow chart of an exemplary procedure 600 for wireless communications in accordance with some embodiments of the present disclosure. Details described in all of the foregoing embodiments of the present disclosure are applicable for the embodiments shown in FIG. 6. In some examples, the procedure may be performed by a BS, for example, BS 102 in FIG. 1.

Referring to FIG. 6, in operation 611, a BS may transmit a first plurality of group-common DCI formats for scheduling a first plurality of PDSCHs for a multicast service. Each of the first plurality of group-common DCI formats may include a DAI. In operation 613, the BS may receive a HARQ-ACK codebook for the multicast service. The HARQ-ACK codebook may be generated based on the DAI in the first plurality of group-common DCI formats.

In some embodiments of the present disclosure, the first plurality of group-common DCI formats may include a first group-common DCI format scheduling a first PDSCH of the first plurality of PDSCHs. In some examples, a bit in the first group-common DCI format may indicate whether HARQ-ACK feedback for the first PDSCH is disabled or enabled. In some examples, a HARQ-ACK feedback related indicator in the first group-common DCI format equal to a predefined value or not may indicate whether the HARQ-ACK feedback for the first PDSCH is disabled or enabled. In some examples, an HTI in the first group-common DCI format indicating an inapplicable value or not may indicate whether the HARQ-ACK feedback for the first PDSCH is disabled or enabled. In some examples, a PRI in the first group-common DCI format indicating an invalid PUCCH resource or not may indicate whether the HARQ-ACK feedback for the first PDSCH is disabled or enabled. In some examples, the DAI in the first group-common DCI format equal to a predefined value or not may indicate whether the HARQ-ACK feedback for the first PDSCH is disabled or enabled. The HARQ-ACK feedback related indicator may include the HTI, the PRI, or any combination thereof.

In some embodiments of the present disclosure, the BS may transmit a second plurality of group-common DCI formats for scheduling a second plurality of PDSCHs for the multicast service. Each of the second plurality of group-common DCI formats may include a DAI and an HEI. The HARQ-ACK codebook may be generated based on the DAIs in the first plurality of group-common DCI formats and the DAIs and HEIs in the second plurality of group-common DCI formats.

In some embodiments of the present disclosure, the DAI in a first group-common DCI format of the first plurality of group-common DCI formats may indicate whether the HARQ-ACK feedback for a first PDSCH scheduled by the first group-common DCI format is enabled or disabled.

In some embodiments, the BS may perform at least one of: in response to the HARQ-ACK feedback for the first PDSCH being disabled, setting the DAI in the first group-common DCI format being the same as that in a second group-common DCI format of the second plurality of group-common DCI formats, which is transmitted earlier than the first group-common DCI format; or in response to the HARQ-ACK feedback for the first PDSCH being enabled, setting the DAI in the first group-common DCI format being updated based on that in the second group-common DCI format. In some examples, the HEI in the second group-common DCI format may indicate enabled HARQ-ACK feedback. In some examples, the HEI in the second group-common DCI format may indicate disabled HARQ-ACK feedback.

In some embodiments, in response to the first group-common DCI format being transmitted earlier than all of the second plurality of group-common DCI formats: the HARQ-ACK feedback for the first PDSCH may be disabled; the HARQ-ACK feedback for the first PDSCH may be enabled; the BS may, in response to the HARQ-ACK feedback for the first PDSCH being disabled, set the DAI in the first group-common DCI format equal to a predefined value and the DAI in a second group-common DCI format of the second plurality of group-common DCI formats which is transmitted earlier than any other group-common DCI formats of the second plurality of group-common DCI formats equal to the predefined value or restarted; or the BS may, in response to the HARQ-ACK feedback for the first PDSCH being enabled, update the DAI in the second group-common DCI format based on the DAI in the first group-common DCI format.

In some embodiments of the present disclosure, the DAIs may be counted separately among a first group of group-common DCI formats and a second group of group-common DCI formats. The first group of group-common DCI formats may include group-common DCI formats each with enabled HARQ-ACK feedback from the first plurality of group-common DCI formats and group-common DCI formats each with an enabled HEI from the second plurality of group-common DCI formats. The second group of group-common DCI formats may include group-common DCI formats each with disabled HARQ-ACK feedback from the first plurality of group-common DCI formats and group-common DCI formats each with a disabled HEI from the second plurality of group-common DCI formats.

In some embodiments of the present disclosure, the BS may transmit RRC signaling indicating whether the HARQ-ACK feedback for the first plurality of PDSCHs is enabled or disabled. In some embodiments of the present disclosure, the HARQ-ACK feedback for the first plurality of PDSCHs may be predefined as enabled or disabled.

It should be appreciated by persons skilled in the art that the sequence of the operations in exemplary procedure 600 may be changed and some of the operations in exemplary procedure 600 may be eliminated or modified, without departing from the spirit and scope of the disclosure.

FIG. 7 illustrates a block diagram of an exemplary apparatus 700 according to some embodiments of the present disclosure. As shown in FIG. 7, the apparatus 700 may include at least one processor 706 and at least one transceiver 702 coupled to the processor 706. The apparatus 700 may be a UE or a BS.

Although in this figure, elements such as the at least one transceiver 702 and processor 706 are described in the singular, the plural is contemplated unless a limitation to the singular is explicitly stated. In some embodiments of the present application, the transceiver 702 may be divided into two devices, such as a receiving circuitry and a transmitting circuitry. In some embodiments of the present application, the apparatus 700 may further include an input device, a memory, and/or other components.

In some embodiments of the present application, the apparatus 700 may be a UE. The transceiver 702 and the processor 706 may interact with each other so as to perform the operations with respect to the UE described in FIGS. 1-6. In some embodiments of the present application, the apparatus 700 may be a BS. The transceiver 702 and the processor 706 may interact with each other so as to perform the operations with respect to the BS described in FIGS. 1-6.

In some embodiments of the present application, the apparatus 700 may further include at least one non-transitory computer-readable medium.

For example, in some embodiments of the present disclosure, the non-transitory computer-readable medium may have stored thereon computer-executable instructions to cause the processor 706 to implement the method with respect to the UE as described above. For example, the computer-executable instructions, when executed, cause the processor 706 interacting with transceiver 702 to perform the operations with respect to the UE described in FIGS. 1-6.

In some embodiments of the present disclosure, the non-transitory computer-readable medium may have stored thereon computer-executable instructions to cause the processor 706 to implement the method with respect to the BS as described above. For example, the computer-executable instructions, when executed, cause the processor 706 interacting with transceiver 702 to perform the operations with respect to the BS described in FIGS. 1-6.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including.” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

What is claimed is:

1. A user equipment (UE) for wireless communication, comprising:
at least one memory; and
at least one processor coupled with the at least one memory and configured to cause the UE to:
receive a first plurality of group-common downlink control information (DCI) formats for scheduling a first plurality of physical downlink shared channels (PDSCHs) for a multicast service, wherein each of the first plurality of group-common DCI formats includes a downlink assignment index (DAI);
determine whether hybrid automatic repeat request acknowledgement (HARQ-ACK) feedback for the first plurality of PDSCHs is disabled or enabled;
generate a HARQ-ACK codebook for the multicast service based on DAIs in the first plurality of group-common DCI formats; and
transmit the HARQ-ACK codebook.

2. The UE of claim 1, wherein to determine whether HARQ-ACK feedback for the first plurality of PDSCHs is disabled or enabled, the at least one processor is configured to cause the UE to determine whether HARQ-ACK feedback for a first PDSCH of the first plurality of PDSCHs scheduled by a first group-common DCI format of the first plurality of group-common DCI formats is disabled or enabled based on at least one of:
a bit in the first group-common DCI format;
whether a HARQ-ACK feedback related indicator in the first group-common DCI format is equal to a predefined value;
whether a HARQ timing indicator in the first group-common DCI format indicates an inapplicable value;
whether a physical uplink control channel (PUCCH) resource indicator (PRI) in the first group-common DCI format indicates an invalid PUCCH resource; or
whether the DAI in the first group-common DCI format is equal to a predefined value.

3. The UE of claim 2, wherein the HARQ-ACK feedback related indicator comprises the HARQ timing indicator, the PRI, or any combination thereof.

4. The UE of claim 1, wherein the at least one processor is further configured to cause the UE to receive a second plurality of group-common DCI formats for scheduling a second plurality of PDSCHs for the multicast service, wherein each of the second plurality of group-common DCI formats includes a DAI and a HARQ-ACK feedback enabling/disabling indicator (HEI); and
wherein to generate the HARQ-ACK codebook for the multicast service, the at least one processor is configured to cause the UE to generate the HARQ-ACK codebook based on the DAIs in the first plurality of group-common DCI formats and the DAIs and HEIs in the second plurality of group-common DCI formats.

5. The UE of claim 4, wherein a DAI in a first group-common DCI format of the first plurality of group-common DCI formats indicates whether the HARQ-ACK feedback for a first PDSCH scheduled by the first group-common DCI format is enabled or disabled.

6. The UE of claim 5, wherein to determine whether the HARQ-ACK feedback for the first plurality of PDSCHs is disabled or enabled, the at least one processor is configured to cause the UE to at least one of:
determine that the HARQ-ACK feedback for the first PDSCH is disabled in response to the DAI in the first group-common DCI format being same as that in a second group-common DCI format of the second plurality of group-common DCI formats, which is transmitted earlier than the first group-common DCI format; or
determine that the HARQ-ACK feedback for the first PDSCH is enabled in response to the DAI in the first group-common DCI format being updated based on that in the second group-common DCI format.

7. The UE of claim 6, wherein the HEI in the second group-common DCI format indicates enabled HARQ-ACK feedback.

8. The UE of claim 5, wherein to determine whether the HARQ-ACK feedback for the first plurality of PDSCHs is disabled or enabled, the at least one processor is configured to cause the UE to, in response to the first group-common DCI format being transmitted earlier than all of the second plurality of group-common DCI formats, at least one of:
determine that the HARQ-ACK feedback for the first PDSCH is disabled;
determine that the HARQ-ACK feedback for the first PDSCH is enabled;
determine that the HARQ-ACK feedback for the first PDSCH is disabled when the DAI in the first group-common DCI format is equal to a predefined value and the DAI in a second group-common DCI format of the second plurality of group-common DCI formats which is transmitted earlier than any other group-common DCI formats of the second plurality of group-common DCI formats is equal to the predefined value or restarted; or
determine that the HARQ-ACK feedback for the first PDSCH is enabled when the DAI in the second group-common DCI format is updated based on the DAI in the first group-common DCI format.

9. The UE of claim 4, wherein the DAIs are counted separately among a first group of group-common DCI formats and a second group of group-common DCI formats;
wherein the first group of group-common DCI formats comprises group-common DCI formats each with enabled HARQ-ACK feedback from the first plurality of group-common DCI formats and group-common DCI formats each with an enabled HEI from the second plurality of group-common DCI formats; and
wherein the second group of group-common DCI formats comprises group-common DCI formats each with disabled HARQ-ACK feedback from the first plurality of group-common DCI formats and group-common DCI formats each with a disabled HEI from the second plurality of group-common DCI formats.

10. The UE of claim 1, wherein the at least one processor is further configured to cause the UE to receive radio resource control (RRC) signaling indicating whether the HARQ-ACK feedback for the first plurality of PDSCHs is enabled or disabled.

11. The UE of claim 1, wherein the HARQ-ACK feedback for the first plurality of PDSCHs is predefined as enabled or disabled.

12. A base station for wireless communication, comprising:
at least one memory; and
at least one processor coupled with the at least one memory and configured to cause the base station to:
transmit a first plurality of group-common downlink control information (DCI) formats for scheduling a first plurality of physical downlink shared channels (PDSCHs) for a multicast service, wherein each of the first plurality of group-common DCI formats includes a downlink assignment index (DAI); and
receive a hybrid automatic repeat request acknowledgement (HARQ-ACK) codebook for the multicast service, wherein the HARQ-ACK codebook is generated based on the DAI in the first plurality of group-common DCI formats.

13. The base station of claim 12, wherein the first plurality of group-common DCI formats comprises a first group-common DCI format scheduling a first PDSCH of the first plurality of PDSCHs, and wherein at least one of:
a bit in the first group-common DCI format indicates whether HARQ-ACK feedback for the first PDSCH is disabled or enabled;
a HARQ-ACK feedback related indicator in the first group-common DCI format equal to a predefined value or not indicates whether the HARQ-ACK feedback for the first PDSCH is disabled or enabled;
a HARQ timing indicator in the first group-common DCI format indicating an inapplicable value or not indicates whether the HARQ-ACK feedback for the first PDSCH is disabled or enabled;
a physical uplink control channel (PUCCH) resource indicator (PRI) in the first group-common DCI format indicating an invalid PUCCH resource or not indicates whether the HARQ-ACK feedback for the first PDSCH is disabled or enabled; or
the DAI in the first group-common DCI format equal to a predefined value or not indicates whether the HARQ-ACK feedback for the first PDSCH is disabled or enabled.

14. The base station of claim 13, wherein the HARQ-ACK feedback related indicator comprises the HARQ timing indicator, the PRI, or any combination thereof.

15. A method performed by a user equipment (UE), comprising:
receiving a first plurality of group-common downlink control information (DCI) formats for scheduling a first plurality of physical downlink shared channels (PDSCHs) for a multicast service, wherein each of the first plurality of group-common DCI formats includes a downlink assignment index (DAI);
determining whether hybrid automatic repeat request acknowledgement (HARQ-ACK) feedback for the first plurality of PDSCHs is disabled or enabled;
generating a HARQ-ACK codebook for the multicast service based on DAIs in the first plurality of group-common DCI formats; and
transmitting the HARQ-ACK codebook.

16. A processor for wireless communication, comprising:
at least one controller coupled with at least one memory and configured to cause the processor to:
receive a first plurality of group-common downlink control information (DCI) formats for scheduling a first plurality of physical downlink shared channels (PDSCHs) for a multicast service, wherein each of the first plurality of group-common DCI formats includes a downlink assignment index (DAI);
determine whether hybrid automatic repeat request acknowledgement (HARQ-ACK) feedback for the first plurality of PDSCHs is disabled or enabled;
generate a HARQ-ACK codebook for the multicast service based on DAIs in the first plurality of group-common DCI formats; and
transmit the HARQ-ACK codebook.

17. The processor of claim 16, wherein to determine whether HARQ-ACK feedback for the first plurality of PDSCHs is disabled or enabled, the at least one controller is configured to cause the processor to determine whether HARQ-ACK feedback for a first PDSCH of the first plurality of PDSCHs scheduled by a first group-common DCI format of the first plurality of group-common DCI formats is disabled or enabled based on at least one of:
a bit in the first group-common DCI format;
whether a HARQ-ACK feedback related indicator in the first group-common DCI format is equal to a predefined value;
whether a HARQ timing indicator in the first group-common DCI format indicates an inapplicable value;
whether a physical uplink control channel (PUCCH) resource indicator (PRI) in the first group-common DCI format indicates an invalid PUCCH resource; or
whether the DAI in the first group-common DCI format is equal to a predefined value.

18. The processor of claim 17, wherein the HARQ-ACK feedback related indicator comprises the HARQ timing indicator, the PRI, or any combination thereof.

19. The processor of claim 16, wherein the at least one controller is further configured to cause the processor to receive a second plurality of group-common DCI formats for scheduling a second plurality of PDSCHs for the multicast service, wherein each of the second plurality of group-common DCI formats includes a DAI and a HARQ-ACK feedback enabling/disabling indicator (HEI); and
wherein to generate the HARQ-ACK codebook for the multicast service, the at least one controller is configured to cause the processor to generate the HARQ-ACK codebook based on the DAIs in the first plurality of group-common DCI formats and the DAIs and HEIs in the second plurality of group-common DCI formats.

20. The processor of claim 19, wherein a DAI in a first group-common DCI format of the first plurality of group-common DCI formats indicates whether the HARQ-ACK feedback for a first PDSCH scheduled by the first group-common DCI format is enabled or disabled.
